(19) United States
(12) Patent Application Publication
(10) Pub. No.: US 2008/0209472 A1
(43) Pub. Date: Aug. 28, 2008

(54) EMPHASIZED MOSAIC VIDEO CHANNEL WITH INTERACTIVE USER CONTROL

(76) Inventors: David Eric Shanks, Los Angeles, CA (US); David B. Hill, Pacific Palisades, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(21) Appl. No.: 11/953,576

(22) Filed: Dec. 10, 2007

Related U.S. Application Data
(60) Provisional application No. 60/874,095, filed on Dec. 11, 2006.

(51) Int. Cl. G06F 13/10; H04N 5/445

(52) U.S. Cl. 725/43; 725/52

(57) ABSTRACT

An interactive mosaic channel video stream is disclosed. Such a channel is displayed on a video monitor, with a plurality of individual video feeds being presented at a given time, comprising a plurality of video cells presenting at least video information, each video cell associated with one of the plurality of individual video feeds, each video cell further comprising a mosaic of related video information, and a cursor, which can be moved between the plurality of video cells, for selecting at least one characteristic associated with a selected video cell, such that the user can then directly select a video program associated with the selected video cell.

### CROSS-REFERENCE TO RELATED APPLICATIONS

This application claims the benefit under 35 U.S.C Section 119(e) of U.S. Provisional Application Ser. No. 60/874,095, filed on Dec. 11, 2006, by David E. Shanks et al., entitled “EMPHASIZED MOSAIC VIDEO CHANNEL WITH INTERACTIVE USER CONTROL,” which application is incorporated by reference herein.

### BACKGROUND OF THE INVENTION

1. Field of the Invention

The present invention relates generally to satellite video systems, and in particular, to a method, apparatus, and article of manufacture for interactive mosaic channel video streams.

2. Description of the Related Art

Satellite broadcasting of communications signals has become commonplace. Satellite distribution of commercial signals for use in television programming currently utilizes multiple feedhorns on a single Outdoor Unit (ODU) which supply signals to up to eight IRDs on separate cables from a multiswitch.

FIG. 1 illustrates a typical satellite television installation of the related art.

System 100 uses signals sent from Satellite A (SatA) 102, Satellite B (SatB) 104, and Satellite C (SatC) 106 that are directly broadcast to an Outdoor Unit (ODU) 108 that is typically attached to the outside of a house 110. ODU 108 receives these signals and sends the received signals to IRD 112, which decodes the signals and separates the signals into viewer channels, which are then passed to monitor 114 for viewing by a user. There can be more than one satellite transmitting from each orbital location.

Satellite uplink signals 116 are transmitted by one or more uplink facilities 118 to the satellites 102-104 that are typically in geosynchronous orbit. Satellites 102-106 amplify and rebroadcast the uplink signals 116, through transponders located on the satellite, as downlink signals 120. Depending on the satellite 102-106 antenna pattern, the downlink signals 120 are directed towards geographic areas for reception by the ODU 108.

Each satellite 102-106 broadcasts downlink signals 120 in typically thirty-two (32) different frequencies, which are licensed to various users for broadcasting of programming, which can be audio, video, or data signals, or any combination. These signals are typically located in the Ku-band of frequencies, i.e., 11-18 GHz. Future satellites will likely broadcast in the Ka-band of frequencies, i.e., 18-40 GHz, but typically 20-30 GHz.

As satellites 102-106 broadcast additional services and additional channels to viewers, viewers will like and expect to see programming on monitor 114 that relate to their specific needs and desires.

### SUMMARY OF THE INVENTION

To minimize the limitations in the prior art, and to minimize other limitations that will become apparent upon reading and understanding the present specification, the present invention discloses an interactive mosaic channel video stream.

Such a channel os displayed on a video monitor, with a plurality of individual video feeds being presented at a given time, and comprises a plurality of video cells presenting at least video information, each video cell associated with one of the plurality of individual video feeds, each video cell further comprising a mosaic of related video information wherein, within the mosaic of related video information, at least one video presentation is emphasized with respect other video presentations within the video cell, and a cursor, which can be moved between the plurality of video cells, for selecting at least one characteristic associated with a selected video cell, such that the user can then directly select a video program associated with the selected video cell.

Such a channel further optionally comprises when the user selects a video program associated with the selected video cell, a secondary video cell is displayed, comprising at least the selected video program, the secondary video cell further comprises a plurality of secondary video feeds, each video feed having an associated audio portion, a secondary video feed is shared between a plurality of the individual video feeds, the shared secondary video feed has a first audio program associated with the shared video feed when displayed on a first secondary video cell, and a second audio program associated with the shared video feed when displayed on a secondary video cell. displaying at least one information bar related to the video feed, a first bar comprises information related to an event shown in the video feed, and a second bar which displays information related to the secondary video feed.

A system in accordance with the present invention displays a plurality of individual video feeds at a given time, and comprises a broadcast delivery system, comprising a transmitter and a receiver, a monitor, coupled to the receiver, for selectively displaying a plurality of video cells presenting at least video information, each video cell associated with one of the plurality of individual video feeds, each video cell further comprising a mosaic of related video information wherein, within the mosaic of related video information, at least one video presentation is emphasized with respect to other video presentations within the video cell, and a cursor, which can be moved between the plurality of video cells, for selecting at least one characteristic associated with a selected video cell, such that the user can then directly select a video program associated with the selected video cell.

Such a system further optionally comprises the broadcast delivery system being a satellite television delivery system, the secondary video cell further comprises a plurality of secondary video feeds, each video feed having an associated audio portion, a secondary video feed is shared between a plurality of the individual video feeds, the shared secondary video feed has a first audio program associated with the shared video feed when displayed on a first secondary video cell, and a second audio program associated with the shared video feed when displayed on a secondary video cell, displaying at least one information bar related to the video feed, a first bar comprises information related to an event shown in the video feed, and a second bar which displays information related to the secondary video feed.

Other features and advantages are inherent in the system disclosed or will become apparent to those skilled in the art from the following detailed description and its accompanying drawings.

### BRIEF DESCRIPTION OF THE DRAWINGS

Referring now to the drawings in which like reference numbers represent corresponding parts throughout:

FIG. 1 illustrates a typical satellite television installation of the related art;

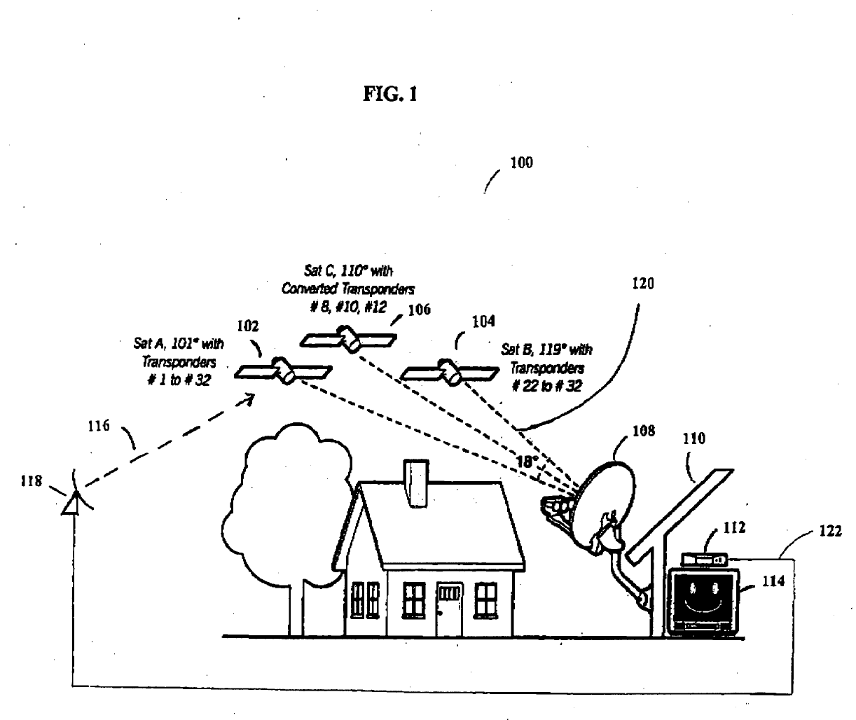

FIG. 2 illustrates a typical eight-cell matrix with a generic video feed in accordance with the present invention;

FIG. 3 illustrates a remote control used in conjunction with the present invention; and

FIG. 4 illustrates a presentation of a highlights channel in accordance with the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

The present invention is an interactive television channel that allows a viewer to view a video stream and select specific audio and/or video from the video stream based on a viewer's individual desires. The video stream is typically delivered to a user's monitor 114 via system 100, but could be done using cable or other terrestrial techniques.

When a viewer watches a specific program on a monitor 114, they are watching a “viewer channel” that comprises video and audio information that is routed to a specific “channel” to the monitor 114. For example, when a viewer wants to watch the local FOX affiliate station, they know that station is associated with a specific channel number on their monitor 114 or IRD 112, e.g., channel 11. When they program or otherwise indicate to the monitor 114 or IRD 112 to tune to channel 11, the monitor 114 or IRD 112 manipulates the electronics to capture and present the video information associated with that command from the satellite downlink 120, or from another source such as a coaxial cable input (cable TV) or terrestrial broadcast frequencies to present that information on monitor 114. The “viewer channel” information is typically the information that is presented when a viewer selects a given “channel” on the monitor 114 or IRD 112.

The present invention provides additional viewer channels that comprise multiple video feeds that would normally be presented to a viewer on separate viewer channels, as well as optionally presenting indicators of what is happening on each video feed. A viewer channel that comprises multiple video feeds from other stand-alone channels is typically called a “mix channel” or a “mosaic channel.”

The present invention also allows a viewer to select various portions of the video and audio presentation based on commands sent by the viewer, typically via the remote control, to select the desired video and audio that is presented. This presentation is typically referred to as an “interactive channel,” an “interactive matrix channel,” or an “interactive mosaic channel” herein.

Within the interactive mosaic channel, the viewer is given several choices of other viewer channels to view, either simultaneously as in a matrix view, or the viewer can choose one of the matrixed viewer channels directly from the interactive mosaic channel.

Further, other presentations of the mix channel can be presented even after a user has selected one of the video feeds to view directly.

There can be more than one interactive channel as described above, and, as such each of the interactive channels can have a thematic core, genre, or subject. For example, the interactive channels can comprise a group of related channels, such as a group of viewer channels that provide news programming, a second group of viewer channels that provide sports programming, a group of channels that provide children's programming, a group of channels that provide home shopping programming, or a group of channels that is selected by the user. Other groupings can be presented, such as all of the local network affiliate channels, specialty groups such as a group of channels that provide foreign-language specific programming, pay-per-view preview channels, sports programming, etc. The present invention is not limited based on the grouping of channels matrixed together to comprise the interactive mosaic channel.

The interactive mosaic channel can be reached in a similar fashion to the other viewer channels available for viewing on monitor 114; the interactive mosaic channel can be selected from the programming guide, the interactive mosaic channel number can be entered directly on the remote control, or the interactive mosaic channel would be found when the user is “channel surfing” or using the “next higher or lower channel” button on the remote control or directly on the monitor 114 or IRD 112.

### Interactive Mosaic Channel Display Diagram

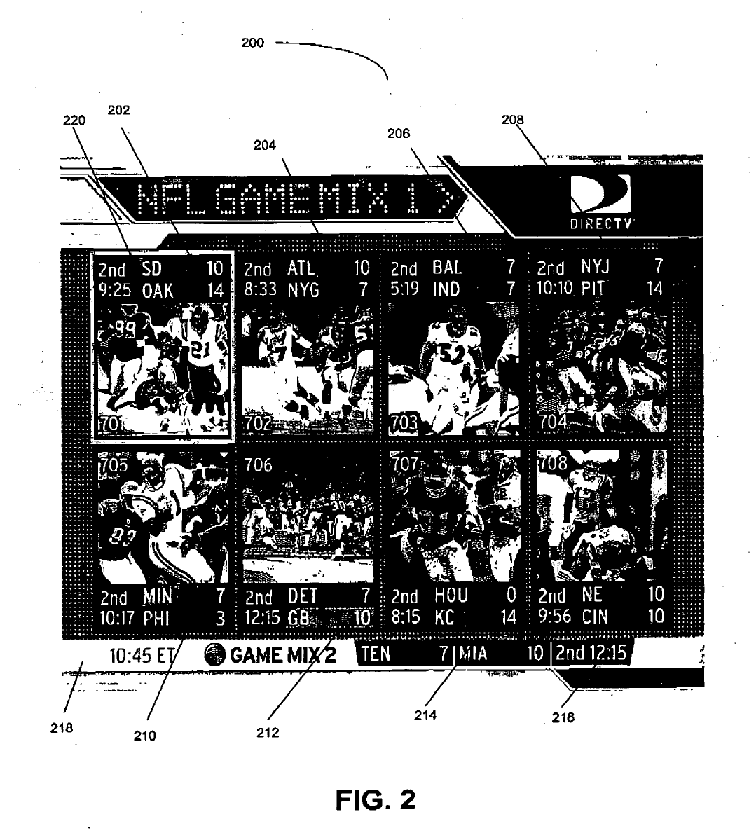

FIG. 2 illustrates a typical eight-cell matrix with a generic video feed in accordance with the present invention.

Interactive mosaic channel 200 is shown as being displayed on monitor 114. Within interactive mosaic channel 200, there are a number of video cells 202-216, a control bar 218, and a cursor 220.

The number of video cells 202-216 can change based on the number of video cells 202-216 desired. As the number of video cells 202-216 increases, of course, there must be a reduction in the size of the video cells 202-216 to ensure that the video cells 202-216 can be differentiated on the monitor 114. As the number of video cells 202-216 decreases, the size of the video cells 202-216 can increase, since there is more space available on monitor 114 to display video cells 202-216.

Further, the placement of video cells 202-216, control bar 218, and other features of channel 200 is not limited to the positions on monitor 114 as shown in FIG. 2. These elements 202-220 can be displayed anywhere on monitor 114 without departing from the scope of the present invention.

As there are multiple video feeds, e.g., one video feed for each video cell 202-216 being presented, each video cell 202-216, as well as other features of channel 200, have associated audio portions that can be played. Presenting more than one audio stream may be confusing to a viewer of monitor 114; as such, it is typical that only one audio stream of information is presented at a given time. Further, each of the video feeds may also have closed-captioning information associated with it, and selection of a closed-captioned presentation, rather than an audio presentation, can be performed if desired.

Video Cells

Video cells 202-216 each typically contain a separate viewer channel of programming. Further, each video cell 202-216 contains other information that is presented within the video cell as described herein.

Channel indicators can be shown within video cells 202-216, to show the viewer the “direct tune” channel number for that video cell 202. When cursor 220 is placed on (or around) that video cell 202, as is shown in FIG. 2, the audio or other associated data for that video cell 202 can be presented to the viewer.

Related Data

There also may be other related data for a given video cell 202-216 that is of interest to a viewer. For example, as shown in video cell 202, the video feed content is a National Football League™ game. Team identifiers indicate that the game in video feed 228 is a contest between the San Diego Chargers and the Oakland Raiders. There is a clock indicator that indicates that this game is in the second quarter, and that there are nine minutes and 25 seconds remaining in the second quarter. When certain events occur, e.g., a game enters the final two minutes of a period or half, the clock indicator can change colors to further indicate to a viewer that the end of a period is coming up. This may be important for certain types of events, and not as important for others, but is available as a graphical display for the clock indicator within the scope of the present invention.

Further, there is a current score, showing that Oakland is winning the game, 14-10. There is also a “possession” indicator, which is shown as a different color or other graphical indicator, that shows that San Diego is currently in possession of the ball. For example, a light blue color of the possession indicator indicates that San Diego is in possession of the ball.

When certain game conditions occur, these graphical indicators may also change color as well as size. For example, when a team gets within twenty yards of the end zone on offense, they are considered in “the red zone” of the field. To indicate such a game condition, the position indicator can turn red, which indicates to a viewer that a team is inside scoring range for either a touchdown or a field goal. When a team scores, the position indicator can flash or turn green, to indicate that the score of the game recently changed. Other indicators are possible, e.g., when a penalty is called, one or both of the position indicators can turn yellow, when a turnover occurs, the recovering team's position indicators can flash orange, etc.

For other types of video feeds, possession indicator and the other graphical indicators may provide other types of information. For example, in a hockey game, possession of the puck by a given team does not necessarily indicate an advantage in the game or an impending score. In an automobile race, the graphical indicators can flash, change color, and present other graphical information to indicate race position, a pass or crash, or other events that occur during the race.

### Placement of Video Cells

The placement for each video cell 202-216 can depend on a wide variety of factors, such as Nielsen ratings for a given channel, whether a given channel is available on a specific viewer's programming package, viewer channel number (lowest to highest or highest to lowest), expected ratings of the video feed, or can be decided or changed based on programming that is present on one or more of the viewer channels available for the interactive mosaic channel.

For example, and not by way of limitation, a game between two division rivals, such as New England and Miami, may have an expected viewer rating higher than a game between two teams that are not doing well in a given season. As such, the New England/Miami game may be placed in video cell 202 rather than in video cell 206, or vice versa. Further, as video cell 202-216 information becomes static, e.g., a game ends, or, conversely, as video cell 202-216 information becomes more important, e.g., a game goes into overtime, placement or movement of the video feeds for the video cells 202-216 can be changed.

Other information may also appear in video cell 202-216, such as an indication that the video feed that is being presented in the associated video cell 202 is a “user favorite” channel, the video cell 202-216 may be presented in a different color or video texture to indicate that the video feed that is being presented in the associated video cell 202 is a channel that presents programming that adults may wish to block from their children's view or has closed-captioning available, etc. Many possibilities are available within the scope of the present invention to present various types of video information within video cell 202-206 for viewer selection and benefit. Further, if the video feed for a given channel has not started yet, e.g., a game has not started yet, a graphic may be displayed to indicate the nature of the upcoming video feed for that video cell 202-216.

Control Bar

The control bar 218 can be used to provide remote control instructions or other information to the viewer. For example, in a sports environment, the control bar 218 can act as a dynamic ticker to provide updated scores or breaking news, or act as an alert system as described herein. The control bar 218 can also be used to present other information, such as statistics, closed captioning information, or other information, that can be related to the genre or to other issues. The control bar 218 can also be updated with new information at a different rate than that of the video cells 202-216, because the source of information that is used to create dynamic ticker 224 comes from a different source than the information that is presented in video cells 202-216.

### Viewer Interaction

By selecting a given video cell 202-216, the viewer is selecting a specific characteristic associated with that given video cell 202-216, or associated video feed used to generate that video cell 202-216. In most instances, when the viewer selects a given video cell 202-216 via cursor 220, an audio portion associated with the selected video cell 202-216 will be presented to the viewer, rather than a generic audio portion associated with interactive mosaic channel 200. Further, selection of a given video cell 202-216 with cursor 220 may also select a closed captioning data stream associated with the selected video cell 202-216, depending on the availability of such a data stream and/or other settings that a viewer has selected. Cursor 220 can be moved to any of the video cells 202-216, and, optionally, can be moved to select text box 218 or ticker 224.

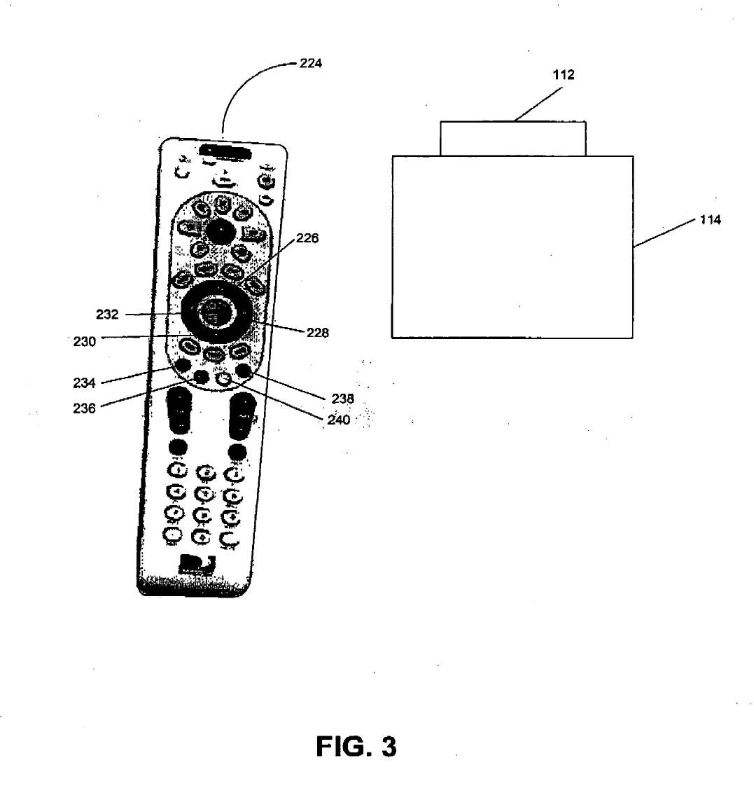

When cursor 220 is moved to a given video cell 202-216, the user can select that video cell by pressing a button on remote control 224, shown in FIG. 3, to select that video cell to go “full screen” on monitor 114. Typically, when the video cell 202-216 is selected by the viewer, indicated by the presence of cursor 220, the video feed is a single video program. However, the present invention nests a multiple video/audio program within each of the video cells 202-216 shown in FIG. 2, and, as such, allows for a mosaic channel to be presented as a single tile within another mosaic channel.

The present invention allows the viewer to “interact” with the interactive mosaic channel 200 on several levels, e.g., to select which of the video cells 202-216 to watch, and, once that video cell is selected, to then interact with the video cell in more depth and degrees than previously allowed by other mosaic channels.

The viewer can decide which audio track to listen to, find out a plot line or other information associated with each of the video programs being presented in the various video cells 202-216, etc. If a specific video cell 202-216 presents video information that is of interest to a viewer, then the viewer can move cursor 220, via a remote control 224 button, to a given video cell 202.

If the viewer decides that the selected video cell 202 is of enough interest, the viewer can then directly tune to the selected video cell 202, i.e., tune directly to that viewer channel that is providing the video and audio used to create video cell 202, by pressing a single button on the remote control 224 (typically the “select” button on a DIRECTV remote control, but could be one of any number of buttons 226-240 shown on remote control 224). This button command will tune the IRD 112 or monitor 114 to that viewer channel, which will then be presented full-screen to the viewer as in a normal television monitor 114 viewing format.

### Default Conditions

When a viewer arrives at a given interactive mosaic channel 200, the position of cursor 220 may default to the first video cell 202, any given video cell 202-216, or not be present at all. The viewer may have to press a button on the remote control to activate the cursor 220. Typically, a viewer moves the cursor 220 by using the up/down/left/right keys on a remote control associated with the IRD 112, but other methods can be used without departing from the scope of the present invention. Further, if IRD 112 is not enabled for any or enough interactive services, the cursor 220 functions may be disabled, either entirely or partially, depending on the capabilities of IRD 112.

There can also be the ability to record interactive mosaic channel 200 which will allow a viewer to record what would be several viewer channels as a single viewer channel, i.e., the recorded interactive mosaic channel 200. However, a recorded version of interactive mosaic channel 200 may act differently than a live-feed interactive mosaic channel 200, because the cursor 220 functions may no longer be consistent with a recorded version of that video information. For example, selection of a video cell 202, in a live-feed version, would tune the IRD 112 to the channel number associated with that video cell 202. When it is a recorded version, selection of that video cell would not tune the IRD 112 to the channel number, but would likely present that recorded video information in a full-monitor 114 format, with possible degradation of picture quality. The ability to record interactive mosaic channel 200 may also be selectively disabled if desired.

### Changes in Interactive Mosaic Channel Display

Some of the interactive mosaic channels 200 may, because of the genre selected for that interactive mosaic channel 200 or for other reasons, may need to have the video cells 202-216 changed from one viewer channel to another, or to have video cells 202-216 added or deleted from the presentation of the interactive mosaic channel 200 on monitor 114. As such, there must be a capability to change the presentation of any given interactive mosaic channel 200. The changes may be of a time-sensitive nature, such as changes in news or sporting events, or a seasonal change, such as additional viewer channels carrying an event such as the NCAA Basketball Tournament, and thus, would be seasonally included in an interactive mosaic channel 200 presentation, or of a programming nature, where a viewer adds or deletes a viewer channel to their programming package and thus access to such a viewer channel is selectively allowed or denied. If such a viewer channel is being used to create a given interactive mosaic channel 200, then the interactive mosaic channel 200 must have the capability of adding that video feed for presentation on the monitor.

For example, in a sports genre interactive mosaic channel 200, it is typically known when a sporting event will start and which viewer channel the event will be carried on. So, interactive mosaic channel 200 can schedule the change to the video feed for that viewer channel as being shown on a video cell 202, or change away from a viewer channel that is no longer carrying a sporting event, based on a schedule or other set time-frame events.

When such changes take place, the service provider (which can be DIRECTV, or some other service provider) can program the interactive mosaic channel 200 to change the video presentation on channel 200. This can be done in a variety of ways, either by selectively blacking out the video cells 202-216, presenting a graphic on the video feed during the changes made to the video cells 202-216, or other methods, presented to the viewer in such a way that the video feeds 228 used to create video cells 202-216 are not visible. It may or may not be desirable to present information on the dynamic ticker 210 that the viewer needs to wait during the change in programming. Once the interactive mosaic channel 200 programming is completed, the service provider would then send the video information that shows the new configuration of video cells 202-216, new text box 204 information, etc. Other methods of performing the change in video presentation of viewer channels are also possible within the scope of the present invention.

The service provider, and the viewer, have the ability to black out or disable viewer channels, and, as such, have the ability to black out or disable not only entire interactive mosaic channels 200, but the individual video feeds that are associated with video cells 202 that are presented within an interactive mosaic channel 200. Further, users may have the ability to create their own interactive mosaic channel 200, depending on the equipment capabilities of IRD 112, monitor 114, or other equipment that a specific viewer may have access to.

### Alerts

If desired, when one of the data indicators reaches a certain condition, or another pre-determined event takes place, a pop-up message can appear on screen 200 to indicate to the viewer that something is happening on a video feed that the viewer is not currently viewing.

For example, with respect to FIG. 2, if the viewer is watching the New England/Cincinnati game (as shown in video cell 216). However, an event may occur in another game, such as a scoring play, a turnover, or a player that the viewer is interested in for fantasy football purposes has thrown a touchdown pass. When these events occur, an alert can be provided to the player, and, if desired, the player can press a button on the remote control to direct tune to that game or event, or to a special channel, e.g., a live highlights channel, that is showing the event in question.

Interactive Gambling

The present invention allows for viewers to interactively place bets using their IRD 112 on contests where such bets are legally allowed. A viewer can place proposition bets, e.g., first score of the day, first penalty, etc., and obtain points or other remuneration for either gambling against others for money or for fun. A viewer can also obtain alerts related to fantasy football players, etc. for fantasy football leagues, fantasy baseball leagues, etc.

Interactive Gaming

The present invention also allows for viewers to participate in the game they are watching. For example, a player can use a video game that is designed or modified to interact with the video feed, such that the player is controlling one of the teams that is seen on the television monitor 114. For example, the offense in a football is controlled by the real players, while the defense is controlled via a joystick, controller, or other device that the viewer is using, such that a viewer can try to intercept a pass from a professional quarterback, hit a baseball pitch thrown by a professional baseball player, or drive a race car against professional race car drivers on the track at the same time the professional athlete is performing. Rather than using a computer to emulate the professional player, which is often done in sports video games, the viewer is playing against the actual player, in real time. Computer control of the outcome of the viewer's efforts may differ from the actual game, and the computer would record these differences and show a computer-generated different outcome than that of the real game. Statistics and scores from the hybridized computer-reality game would be recorded separately from those statistics from the actual game. The viewer can control whether to continue to view the actual game, the hybridized game, or the computer-generated game, depending on viewer preferences.

### Fantasy Gaming

The present invention also allows for users to follow and select individual drivers, teams, or create a fantasy team of drivers, and compare their driver/team against other fantasy drivers/teams throughout the racing season. Statistics for each team and/or driver can be made available on a screen or screens associated with mosaic channel 200.

### Genre-Specific Information

The present invention has the ability to take on an embodiment that is genre-specific, e.g., can be augmented or changed based on the genre that the viewer channel is presenting. For example, and not by way of limitation, the present invention can be presented in one way for the NCAA tournament, and another way for NASCAR racing channels.

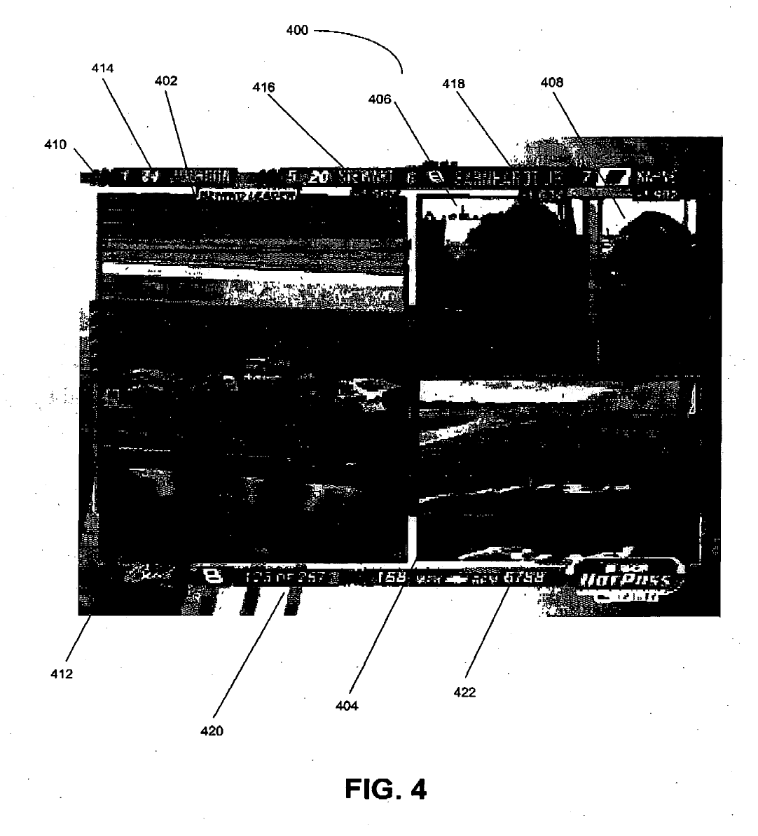

One embodiment of the present invention is to allow a viewer multiple viewpoints of the same programming, as in a NASCAR environment. FIG. 4 illustrates a NASCAR-specific presentation of a nested video channel 400 of the present invention.

Video channel 400 presents various video programs, e.g., the general race feed 402, a driver camera view 404, a crew chief camera view 406, and a pit camera view 408, along with a control bar 410 and a second control bar 412. Video channel 400 is one video feed that is presented as a video cell 202-216; several video channels 400 allow for different drivers in a given NASCAR race to be followed, or different teams in a given NASCAR race to be followed, by a given viewer. Such video channels allow the viewer to “ride shotgun” with their favorite drivers, as well as see the race from a crew chief's perspective.

The present invention allows the viewer to see what a selected driver sees, follow a specific driver or team, and allows specialty audio and video presentations, based on the selected channel from a genre-based mosaic channel, or allows the user to select between audio channels within a mosaic channel. Further, each of the video cells of the mosaic channel can itself be a mosaic channel, as described herein.

For example, and not by way of limitation, each week during the NASCAR NEXTEL Cup Series, the present invention allows race fans the video and audio seen from a “behind the wheel” perspective, an “in the pits” perspective, and an “around the track” perspective with their favorite NASCAR drivers and teams, by offering five fully-produced video channels which follow five different drivers from the green flag to the checkered flag during every race. Each of the five dedicated driver channels can offer multiple camera angles, real-time statistics, in-car audio communication and a dedicated announcer team, among other items as desired.

The present invention, which can be combined with race day telecasts and nascar.com coverage as desired, gives racing fans the most comprehensive and powerful NASCAR experience possible. While the NASCAR viewing experience to date focuses predominately on the race and the ongoing battles taking place on the track between teams, the present invention brings to life the drama that exists within each racing team as they execute the decisions that make or break a race. The presentation of the race in such a format allows the viewer to be part of the drama and involves the viewer in the event to a much greater degree than merely watching the cars travel around the track. With the present invention, the viewer is privy to the dialogue and strategy involved in every critical move for a given car or team. Like the crew chief, they'll know where the driver stands in the field because both the network broadcast and the driver cameras will be on the same screen.

The present invention has several embodiments and elements, including a plurality of dedicated driver channels, each channel dedicated to broadcasting one NASCAR driver throughout the race, multiple screens on each driver channel devoted to the following: Live national broadcast of the race, the drivers point-of-view camera

looking out of the front windshield, with select telemetry readings, additional camera angles including an overhead cam, pit box cam and corner cams, live audio of the two-way communications between the driver, crew chief and spotter, dedicated announcers for each driver channel, and real time statistics for each car, team and the race as a whole. Further, for a given driver, the general race, driver's perspective, crew chief's perspective, and other video and audio information is presented to the viewer on one single channel all at one time. The viewer then interacts with the channel to select which audio and/or video the viewer wishes to focus on for that particular part of the race.

General Video 402

The general video 402 is a video and audio presentation of the race. As shown in FIG. 4, the general video 402 is shown as a larger, or emphasized video presentation, with respect to videos 404-408. When a cursor 220 is moved through the videos 402-408, the videos 402-408 can move positions on monitor 114, or can be presented in a static way that emphasizes certain videos 402 with respect to the remaining videos 404-408.

Although the video may be shared among the video channels 400 that are being broadcast for each of the video channels 400 available on mosaic channel 200, the audio portion can be specific to a given channel 400. For example, and not by way of limitation, the video of the race leaders shown in general video 402 may be the same video information; however, for the Jimmy Johnson team video channel 400, a first audio program may be used to discuss Jimmy Johnson's tactics, strategy, and his place in the race standings. However, for a different video channel 400 that is following Dale Earnhardt Jr.'s car, a different audio program may be used to discuss those strategy and tactical issues that are affecting Dale Earnhardt in the race. Further, for any given channel 400, multiple audio channels can be available to the viewer depending on the position of the cursor; for example, and not by way of limitation, when the cursor is on general video 402, the network audio track may be played; when driver camera video 404 is selected by the cursor, a different audio track may be played.

Driver Cam Video 404

The driver camera video 404 shows a unique perspective of the race; the perspective of a specific driver. The driver camera video 404 can also have a separate audio program for the driver that is being displayed and/or followed on a given video channel 400. Further, this video and audio can be closed-circuit video/audio, such that these images are not available to the general public or other broadcasters of the race being shown in general video 402.

Crew Chief Video 406

The crew chief camera video 406 shows a unique perspective of the race; the perspective of a specific crew chief. The crew chief camera video 406 can also have a separate audio program for the driver that is being displayed and/or followed on a given video channel 400. Further, this video and audio can be closed-circuit video/audio, such that these images are not available to the general public or other broadcasters of the race being shown in general video 402.

Pit Crew Video 408

The pit crew video 408 shows a unique perspective of the race; the perspective of a specific pit crew. The pit crew camera video 408 can also have a separate audio program for the driver that is being displayed and/or followed on a given video channel 400. Further, this video and audio can be closed-circuit video/audio, such that these images are not available to the general public or other broadcasters of the race being shown in general video 402.

Leader Bar 410

The leader bar 410 illustrates the race leader in position 414, the second place driver in position 416, along with the time differential between the leader and the second place driver, and the third place driver in position 418, along with the time differential between the leader and the third place driver. Other time differentials can be displayed without departing from the scope of the present invention. Additional drivers can be displayed, and these additional drivers can be accessed by remote control 224 functions if desired.

Statistics Bar 412

Statistics bar 412 displays the lap number that the race is on in position 420, and statistics on the car being followed by the given video channel 400 in position 422. For example, and not by way of limitation, the RPM of the car (in FIG. 4, this is the #8 car of Dale Earnhardt Jr., as indicated on statistics bar 412), is currently at 5788 rpm. This, and other statistics, such as GPS position, acceleration, braking, engine temperature, speed, etc. can be accessed, either by remote control 224 selection, or random or periodic display of these statistics on statistics bar 412.

### CONCLUSION

The present invention discloses an interactive mosaic video channel. Such a channel os displayed on a video monitor, with a plurality of individual video feeds being presented at a given time, and comprises a plurality of video cells presenting at least video information, each video cell associated with one of the plurality of individual video feeds, each video cell further comprising a mosaic of related video information wherein, within the mosaic of related video information, at least one video presentation is emphasized with respect other video presentations within the video cell, and a cursor, which can be moved between the plurality of video cells, for selecting at least one characteristic associated with a selected video cell, such that the user can then directly select a video program associated with the selected video cell.

Such a channel further optionally comprises when the user selects a video program associated with the selected video cell, a secondary video cell is displayed, comprising at least the selected video program, the secondary video cell further comprises a plurality of secondary video feeds, each video feed having an associated audio portion, a secondary video feed is shared between a plurality of the individual video feeds, the shared secondary video feed has a first audio program associated with the shared video feed when displayed on a first secondary video cell, and a second audio program associated with the shared video feed when displayed on a secondary video cell. displaying at least one information bar related to the video feed, a first bar comprises information related to an event shown in the video feed, and a second bar which displays information related to the secondary video feed.

A system in accordance with the present invention displays a plurality of individual video feeds at a given time, and comprises a broadcast delivery system, comprising a transmitter and a receiver, a monitor, coupled to the receiver, for selectively displaying a plurality of video cells presenting at least video information, each video cell associated with one of the plurality of individual video feeds, each video cell further comprising a mosaic of related video information wherein, within the mosaic of related video information, at least one video presentation is emphasized with respect to other video presentations within the video cell, and a cursor, which can be moved between the plurality of video cells, for selecting at least one characteristic associated with a selected video cell, such that the user can then directly select a video program associated with the selected video cell.

Such a system further optionally comprises the broadcast delivery system being a satellite television delivery system, the secondary video cell further comprises a plurality of secondary video feeds, each video feed having an associated audio portion, a secondary video feed is shared between a plurality of the individual video feeds, the shared secondary video feed has a first audio program associated with the shared video feed when displayed on a first secondary video cell, and a second audio program associated with the shared video feed when displayed on a secondary video cell, displaying at least one information bar related to the video feed, a first bar comprises information related to an event shown in the video feed, and a second bar which displays information related to the secondary video feed.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but by the claims appended hereto and the full range of equivalents of the claims appended hereto.

What is claimed is:

1. An interactive matrixed video channel displayed on a video monitor, with a plurality of individual video feeds being presented at a given time, comprising
a plurality of video cells presenting at least video information, each video cell associated with one of the plurality of individual video feeds, each video cell further comprising a mosaic of related video information wherein, within the mosaic of related video information, at least one video presentation is emphasized with respect other video presentations within the video cell; and
a cursor, which can be moved between the plurality of video cells, for selecting at least one characteristic associated with a selected video cell, such that the user can then directly select a video program associated with the selected video cell.

2. The interactive matrixed video channel of claim 1, wherein when the user selects a video program associated with the selected video cell, a secondary video cell is displayed, comprising at least the selected video program.

3. The interactive matrixed channel of claim 2, wherein the secondary video cell further comprises a plurality of secondary video feeds, each video feed having an associated audio portion.

4. The interactive matrixed channel of claim 3, wherein a secondary video feed is shared between a plurality of the individual video feeds.

5. The interactive matrixed channel of claim 4, wherein the shared secondary video feed has a first audio program associated with the shared video feed when displayed on a first secondary video cell, and a second audio program associated with the shared video feed when displayed on a secondary video cell.

6. The interactive matrixed channel of claim 1, further comprising displaying at least one information bar related to the video feed.

7. The interactive matrixed channel of claim 6, wherein a first bar comprises information related to an event shown in the video feed.

8. The interactive matrixed channel of claim 7, further comprising a second bar which displays information related to the secondary video feed.

9. A system for displaying a plurality of individual video feeds at a given time, comprising:
a broadcast delivery system, comprising a transmitter and a receiver;
a monitor, coupled to the receiver, for selectively displaying a plurality of video cells presenting at least video information, each video cell associated with one of the plurality of individual video feeds, each video cell further comprising a mosaic of related video information wherein, within the mosaic of related video information, at least one video presentation is emphasized with respect to other video presentations within the video cell; and
a cursor, which can be moved between the plurality of video cells, for selecting at least one characteristic associated with a selected video cell, such that the user can then directly select a video program associated with the selected video cell.

10. The system of claim 9, wherein the broadcast delivery system is a satellite television delivery system.

11. The system of claim 9, wherein the secondary video cell further comprises a plurality of secondary video feeds, each video feed having an associated audio portion.

12. The system of claim 9, wherein a secondary video feed is shared between a plurality of the individual video feeds.

13. The system of claim 12, wherein the shared secondary video feed has a first audio program associated with the shared video feed when displayed on a first secondary video cell, and a second audio program associated with the shared video feed when displayed on a secondary video cell.

14. The system of claim 9, further comprising displaying at least one information bar related to the video feed.

15. The system of claim 9, wherein a first bar comprises information
